(19) United States
(12) Patent Application Publication
(10) Pub. No.: US 2024/0070615 A1
(43) Pub. Date: Feb. 29, 2024

(54) WORK SUPPORT METHOD, WORK SUPPORT DEVICE, AND RECORDING MEDIUM

(71) Applicant: Panasonic Intellectual Property Corporation of America, Torrance, CA (US)

(72) Inventors: Kotaro SAKATA, Osaka (JP); Tsuyoki NISHIKAWA, Osaka (JP); Tetsuji FUCHIKAMI, Osaka (JP)

(21) Appl. No.: 18/383,171

(22) Filed: Oct. 24, 2023

Related U.S. Application Data
(63) Continuation of application No. PCT/JP2022/003291, filed on Jan. 28, 2022.

(30) Foreign Application Priority Data
Apr. 26, 2021 (JP) 2021-074427

(51) Int. Cl. G06Q 10/101; G06F 30/12; G06T 19/20; G10L 15/22

(52) U.S. Cl. CPC G06Q 10/101; G06F 30/12; G06T 19/20; G10L 15/22; G06F 2111/02

(57) ABSTRACT

A work support method, for supporting work performed by multiple users including a target user on an object in a virtual space where the object is placed, includes obtaining first information including at least one of sound information, input information, or schedule information; obtaining second information indicating manipulation of the object by the target user; determining whether the manipulation by the target user is to be applied to one or more other users among the multiple users based on the first information; generating images each viewed by a corresponding one of the one or more other users based on the result of the determining and the second information; and outputting the generated images to terminals of the one or more other users.

### CROSS REFERENCE TO RELATED APPLICATIONS

This is a continuation application of PCT International Application No. PCT/JP2022/003291 filed on Jan. 28, 2022, designating the United States of America, which is based on and claims priority of Japanese Patent Application No. 2021-074427 filed on Apr. 26, 2021. The entire disclosures of the above-identified applications, including the specifications, drawings and claims are incorporated herein by reference in their entirety.

### FIELD

The present disclosure relates to a work support method, a work support device, and a recording medium.

### BACKGROUND

In technologies such as virtual reality, a technology of reflecting movements of users' bodies in the real world in avatars and the like in virtual spaces has been studied. According to such a technology, users wearing terminals such as head-mounted displays can, for example, touch objects in virtual spaces by moving their bodies in the real world while viewing the state in the virtual spaces. This allows the users to have a highly realistic experience in the virtual spaces. For example, Patent Literature (PTL) 1 discloses a device allowing various input (manipulation) to objects in a virtual space.

### CITATION LIST

### Patent Literature

PTL 1: Japanese Patent No. 6535641

### SUMMARY

### Technical Problem

In the above-described technology, multiple users who are in different places separate from each other may share the same virtual space and work on an object in the shared virtual space. In this case, reflecting manipulation of the object by a certain user equally in images viewed by other users may cause the other users to feel a sense of strangeness due to the change in the object made without the intention of the other users.

The present disclosure provides a work support method, a work support device, and a recording medium that allow manipulation of an object in a virtual space by a certain user to be appropriately applied to other users.

### Solution to Problem

A work support method according to an aspect of the present disclosure is a work support method for supporting work performed by a plurality of users including a target user on at least one object in a virtual space where the at least one object is placed, and includes obtaining first information including at least one of sound information based on speech by at least one user among the plurality of users, input information based on input from the at least one user among the plurality of users, or schedule information based on a plan about the work; obtaining second information indicating manipulation of the at least one object by the target user; determining whether the manipulation by the target user is to be applied to one or more other users among the plurality of users based on the first information; generating images each viewed by a corresponding one of the one or more other users based on a result of the determining and the second information; and outputting the images that are generated to terminals of the one or more other users.

A work support device according to an aspect of the present disclosure is a work support device that supports work performed by a plurality of users including a target user on at least one object in a virtual space where the at least one object is placed, and includes a first obtainer that obtains first information including at least one of sound information based on speech by at least one user among the plurality of users, input information indicating input from the at least one user among the plurality of users, or schedule information indicating a plan about the work; a second obtainer that obtains second information indicating manipulation of the at least one object by the target user; a determiner that conducts determination of whether the manipulation by the target user is to be applied to one or more other users among the plurality of users based on the first information; a generator that generates images each viewed by a corresponding one of the one or more other users based on a result of the determination and the second information; and an outputter that outputs the images that are generated to terminals of the one or more other users.

A recording medium according to an aspect of the present disclosure is a non-transitory computer-readable recording medium having recorded thereon a program for causing a computer to execute the above-described work support method.

### Advantageous Effects

According to an aspect of the present disclosure, a work support method and the like that allow manipulation of an object in a virtual space by a certain user to be appropriately applied to other users can be achieved.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates an overall configuration of a work support system according to an embodiment.

FIG. 2 is a block diagram illustrating a functional configuration of an information processor according to the embodiment.

FIG. 3 is a flowchart illustrating operation of the information processor according to the embodiment.

FIG. 4 is a flowchart illustrating an example of details of step S13 illustrated in FIG. 3.

FIG. 5 illustrates whether manipulation by a target user is to be applied to each user when determination in step S25 illustrated in FIG. 4 is conducted.

FIG. 6 illustrates whether the manipulation by the target user is to be applied to each user when determination in step S27 illustrated in FIG. 4 is conducted.

FIG. 7 illustrates whether the manipulation by the target user is to be applied to each user when determination in step S28 illustrated in FIG. 4 is conducted.

FIG. 8 illustrates schedule information according to the embodiment.

### DESCRIPTION OF EMBODIMENT

A work support method according to an aspect of the present disclosure is a work support method for supporting work performed by a plurality of users including a target user on at least one object in a virtual space where the at least one object is placed, and includes obtaining first information including at least one of sound information based on speech by at least one user among the plurality of users, input information based on input from the at least one user among the plurality of users, or schedule information based on a plan about the work; obtaining second information indicating manipulation of the at least one object by the target user; determining whether the manipulation by the target user is to be applied to one or more other users among the plurality of users based on the first information; generating images each viewed by a corresponding one of the one or more other users based on a result of the determining and the second information; and outputting the images that are generated to terminals of the one or more other users.

Thus, it is determined whether the manipulation of the at least one object by the target user is to be reflected in the images viewed by the one or more other users based on the first information. That is, the manipulation by the target user is not reflected equally in the images viewed by the one or more other users. Moreover, the determining can be conducted according to the target user as the first information includes at least one of the sound information, the input information, or the schedule information. Accordingly, the manipulation of the object in the virtual space by the target user (certain user) can be appropriately applied to the one or more other users.

Moreover, for example, the first information may include at least the sound information, and the determining may be conducted based on a result of an analysis obtained by analyzing content of the speech by the at least one user based on the sound information.

Thus, it can be determined whether the manipulation by the target user is to be reflected in the images viewed by the one or more other users based on the content of the speech by the users in the virtual space. For example, the manipulation by the target user can be reflected in the images viewed by the one or more other users when it is determined that the manipulation should be applied to the one or more other users according to the content of the speech. Accordingly, the manipulation of the object in the virtual space by the target user can be appropriately applied to the one or more other users according to the content of the speech.

Moreover, for example, the determining may include determining whether either a group work mode in which the plurality of users work in a coordinated manner or an individual work mode in which the plurality of users work individually is active for each of time sections based on the first information and determining that the manipulation by the target user in each of the time sections in which the group work mode is determined to be active is to be applied to the one or more other users and that the manipulation by the target user in each of the time sections in which the individual work mode is determined to be active is not to be applied to the one or more other users.

Thus, it can be determined whether the manipulation by the target user is to be reflected in the images viewed by the one or more other users according to the current work mode. Accordingly, the manipulation of the object in the virtual space by the target user can be appropriately applied to the one or more other users according to the work mode.

Moreover, for example, the determining may further include, when the group work mode is determined to be active, determining whether the target user is a presenter and determining that the manipulation by the target user is to be applied to the one or more other users when the target user is determined to be the presenter and that the manipulation by the target user is not to be applied to the one or more other users when the target user is determined not to be the presenter.

Thus, it can be determined whether the manipulation by the target user is to be reflected in the images viewed by the one or more other users based on whether the target user is a presenter. Accordingly, the manipulation of the object in the virtual space by the target user can be appropriately applied to the one or more other users according to whether the target user is a presenter.

Moreover, for example, the first information may include at least the input information, and the input information may include information indicating whether the target user is the presenter.

Thus, it can be easily determined whether the target user is a presenter only by obtaining the input information.

Moreover, for example, in the generating, the manipulation by the target user may be reflected in the images viewed by the one or more other users when the manipulation by the target user is determined to be applied to the one or more other users, and the manipulation by the target user may not be reflected in the images viewed by the one or more other users when the manipulation by the target user is determined not to be applied to the one or more other users.

Thus, the manipulation by the target user can be shared with the one or more other users only when the manipulation by the target user is determined to be applied to the one or more other users.

Moreover, for example, in the generating, when the manipulation by the target user is determined to be applied to the one or more other users, the manipulation by the target user may be reflected in an image viewed by at least one specific user among the plurality of users and may not be reflected in an image viewed by a user other than the at least one specific user among the one or more other users.

Thus, the manipulation by the target user can be reflected in the image viewed only by the at least one specific user, not by all the one or more other users. Accordingly, the manipulation of the object in the virtual space by the target user can be applied only to more appropriate users among the one or more other users. Moreover, the volume of traffic between the terminals of the users and an information processor can be reduced compared with a case where the manipulation is reflected in the images viewed by all the users included in the one or more other users.

Moreover, for example, the at least one specific user may be determined in advance for each of the plurality of users.

Thus, the manipulation by the target user can be reflected in the images viewed by the users who are determined in advance. Accordingly, the manipulation of the object in the virtual space by the target user can be applied only to more appropriate users.

Moreover, for example, the at least one specific user may be determined according to input from the target user in a period in which the manipulation by the target user is determined to be applied to the one or more other users.

Thus, the manipulation by the target user can be reflected in the images viewed by the users selected by the target user. That is, the manipulation by the target user can be reflected in the image viewed by the at least one specific user intended by the target user. Accordingly, the manipulation of the object in the virtual space by the target user can be applied only to more appropriate users.

Moreover, for example, the at least one specific user may be determined based on at least one of information indicating positions of the one or more other users in the virtual space or information indicating attributes of the one or more other users.

Thus, the users to whom the manipulation by the target user is to be applied can be determined based on at least one of positional relationships between the users in the virtual space or the attributes of the one or more other users. That is, the users to whom the manipulation by the target user is to be applied can be determined according to the state in the virtual space. Accordingly, the manipulation of the object in the virtual space by the target user can be applied only to more appropriate users.

Moreover, for example, the first information may include at least the schedule information, and the schedule information may include information indicating a time period during which the group work mode is active and a time period during which the individual work mode is active.

Thus, the current work mode can be easily determined only by obtaining the schedule information.

Moreover, for example, the manipulation of the at least one object may include at least one of moving, rotating, enlarging, or shrinking the at least one object.

Thus, the manipulation, including at least one of moving, rotating, enlarging, or shrinking, of the at least one object in the virtual space by the target user can be reflected in the images viewed by the one or more other users.

Moreover, a work support device according to an aspect of the present disclosure is a work support device that supports work performed by a plurality of users including a target user on at least one object in a virtual space where the at least one object is placed, and includes a first obtainer that obtains first information including at least one of sound information based on speech by at least one user among the plurality of users, input information indicating input from the at least one user among the plurality of users, or schedule information indicating a plan about the work; a second obtainer that obtains second information indicating manipulation of the at least one object by the target user; a determiner that conducts determination of whether the manipulation by the target user is to be applied to one or more other users among the plurality of users based on the first information; a generator that generates images each viewed by a corresponding one of the one or more other users based on a result of the determination and the second information; and an outputter that outputs the images that are generated to terminals of the one or more other users. Moreover, a recording medium according to an aspect of the present disclosure is a non-transitory computer-readable recording medium having recorded thereon a program for causing a computer to execute the above-described work support method.

These produce effects similar to those produced by the above-described work support method.

Note that general or specific aspects of the present disclosure may be achieved by systems, methods, integrated circuits, computer programs, or non-transitory computer-readable recording media, such as CD-ROMs, or may be achieved by any combinations of systems, methods, integrated circuits, computer programs, and recording media. The programs may be stored in the recording media in advance or may be supplied to the recording media through wide area networks including the Internet.

Hereinafter, embodiments will be described in detail with reference to the drawings.

Note that each of the embodiments described below illustrates a general or specific example. The numerical values, elements, positions and connections of the elements, steps, order of steps, and the like shown in the following embodiments are mere examples and are not intended to limit any aspect of the present disclosure. For example, the numerical values are not expressions representing exact meanings only, but are expressions meaning that substantially equivalent ranges, for example, differences of about several percent, are also included. Moreover, among the elements in the following embodiments, those that are not recited in any of the independent claims are described as optional elements.

Moreover, each drawing is a schematic diagram and is not necessarily illustrated in precise dimensions. Thus, for example, the drawings are not necessarily drawn on the same scale. Moreover, substantially identical configurations are given the same reference signs throughout the drawings, and duplicate explanations are omitted or simplified.

Moreover, in this specification, numerical values and numerical ranges are not expressions representing exact meanings only, but are expressions meaning that substantially equivalent ranges, for example, differences of about several percent (for example, about 5%), are also included.

### EMBODIMENT

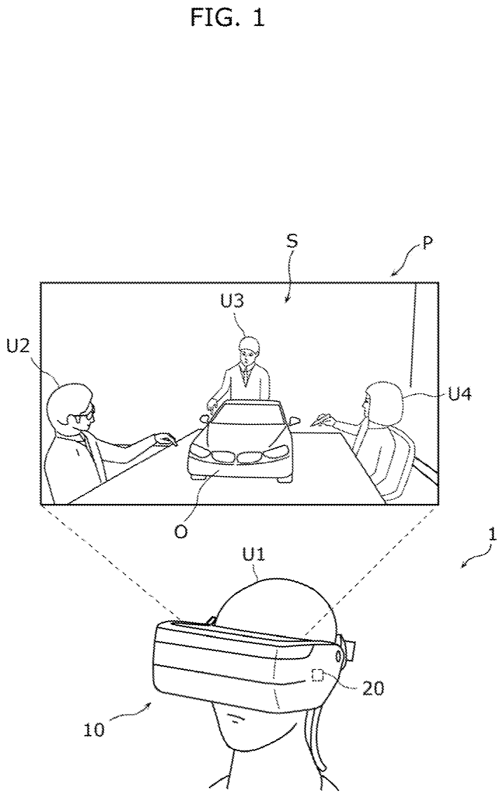

A work support system according to this embodiment will now be described with reference to FIGS. 1 to 8.

### [1. Configuration of Work Support System]

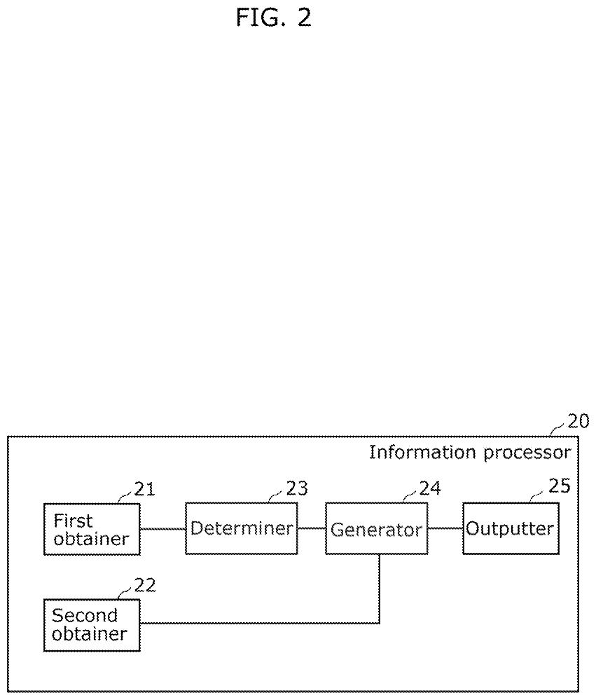

First, a configuration of the work support system according to this embodiment will be described with reference to FIGS. 1 and 2. FIG. 1 illustrates an overall configuration of work support system 1 according to this embodiment.

As illustrated in FIG. 1, work support system 1 includes head-mounted display 10 in which information processor 20 is integrated. FIG. 1 illustrates only head-mounted display 10 worn by user U1. However, head-mounted displays 10 worn by users U2 to U4 also include information processors 20 integrated therein.

FIG. 1 illustrates an example where four users (users U1 to U4) are (present) in virtual space S. The following describes head-mounted display 10 or the like worn by user U1, although other users U2 to U4 may wear similar head-mounted displays 10 or the like.

Head-mounted display 10 is of, for example, an eyeglass type with built-in information processor 20 and shows user U1 image P obtained from information processor 20. In the example illustrated in FIG. 1, head-mounted display 10 shows user U1 image P including avatars that represent users U2 to U4 and object O in virtual space S. Object O is a virtual object that lies in virtual space S. In this embodiment, object O is an automobile, and work support system 1 is used for, for example, a design review meeting to discuss the design of the automobile. Note that object O is not limited to the automobile and may be any object in virtual space S. Moreover, the use of work support system 1 is not limited in particular, and work support system 1 may be used for any purposes other than the design review meeting.

Head-mounted display 10 may be implemented as a so-called standalone device that executes stored programs without depending on external processors, such as servers (for example, cloud servers) and image processors, or may be implemented as a device connected to external processors through networks to execute applications and to transmit and receive data.

Head-mounted display 10 may be of a transmission type or a non-transmission type. Head-mounted display 10 is an example of a terminal.

Note that each of users U1 to U4 (hereinafter also referred to as “user U1 and the like”) can manipulate object O in virtual space S. How user U1 and the like manipulate object O is not limited in particular. For example, user U1 may have a controller (not illustrated) by hand to manipulate object O by, for example, moving the controller. Moreover, user U1 and the like may manipulate object O by voice. In this case, work support system 1 includes a sound collector (for example, microphone) or the like. Moreover, user U1 and the like may manipulate object O by gestures and the like. In this case, work support system 1 includes a camera or the like. The controller, the sound collector, the camera, and the like are connected to information processor 20 to be able to communicate with information processor 20. The sound collector and the camera may be integrated in head-mounted display 10.

The number of objects O that lie in virtual space S is not limited in particular, and need only be one or more.

Information processor 20 is a device for supporting work performed on objects by multiple users including a target user in virtual space S where object O is placed. Information processor 20 executes processes for, for example, generating image P shown on head-mounted display 10. For example, upon obtaining manipulation of object O by user U1 and determining that a predetermined condition is met, information processor 20 generates image P according to the manipulation and outputs image P to other users U2 to U4. Information processor 20 is an example of a work support device. Note that the target user may be, for example, a user who has performed the manipulation of object O among user U1 and the like. The following describes a case where the target user is user U1.

When user U1 manipulates object O in such work support system 1, the manipulation of object O by user U1 may or may not be applied to the other users (for example, at least one of users U2 to U4). Information processor 20 according to this embodiment executes processes for appropriately applying the manipulation of object O by user U1 to the other users.

The manipulation herein is manipulation that causes the appearance of object O to be changed. In this embodiment, the manipulation may include manipulation for at least one of moving, rotating, enlarging, or shrinking object O in virtual space S. Moreover, the manipulation may include, for example, manipulation causes the design of object O to be changed. Moreover, the manipulation may be, for example, manipulation for changing at least one of the color, shape, or texture of object O. Moreover, the manipulation may be, for example, manipulation for hiding or deleting object O from virtual space S or for showing other object O in virtual space S.

Note that “reflecting” refers to a process of applying changes similar to those in the appearance of object O caused by the manipulation by the target user to objects O at which the other users are looking. For example, “reflecting” causes changes in the appearance of object O after the manipulation by the target user, that is, object O at which the target user is looking and changes in the appearance of objects O at which the other users are looking to be the same. “Reflecting” refers to a process of sharing the changes in the appearance of object O before and after the manipulation by the target user with the other users. For example, in a case where the target user performs manipulation for increasing the size of object O by a factor of two, “reflecting the manipulation” includes increasing the size of objects O at which the other users are looking by a factor of two. Note that “reflecting” does not include matching the viewpoint (camera position) of the target user and those (camera positions) of the other users. For example, “reflecting the manipulation for increasing the size” described above does not include causing objects O viewed by the other users to be the same as the image viewed from the camera position of the target user (for example, switching to the image).

Moreover, “reflecting” does not include applying the changes in the viewpoint of the target user to the viewpoints of the other users. For example, in a case where the target user moves the viewpoint by 90 degrees when viewed from above (for example, in a case where the target user looking at object O from the front moves the viewpoint to look at object O from a side), “reflecting” does not include causing the viewpoints of the other users looking at objects O to move by 90 degrees when viewed from above. Even when the target user looking at object O changes their viewpoint, the viewpoints of the other users looking at objects O are not changed.

That is, “reflecting” is a process for sharing, out of manipulation of object O (for example, enlarging object O) and of the avatar (for example, moving the viewpoint) by the target user, only the manipulation of object O with the other users.

Next, a configuration of information processor 20 will be described with reference to FIG. 2. FIG. 2 is a block diagram illustrating a functional configuration of information processor 20 according to this embodiment.

As illustrated in FIG. 2, information processor 20 includes first obtainer 21, second obtainer 22, determiner 23, generator 24, and outputter 25. Information processor 20 is a computer including a processor (microprocessor), a user interface, a communication interface, and memory. The user interface includes, for example, an input/output device, such as a display, a keyboard, and a touch panel. The memory is ROM, RAM, or the like and can store control programs (computer programs) executed by the processor. First obtainer 21, second obtainer 22, determiner 23, generator 24, and outputter 25 are implemented as the processor operates according to the control programs. Note that information processor 20 may include one or more memories.

First obtainer 21 obtains first information including at least one of sound information based on speech by user U1 and the like, input information based on input from user U1 and the like, or schedule information indicating schedules that indicate plans about work performed on object O.

First obtainer 21 obtains, for example, sound information based on speech by at least one user among user U1 and the like. In a case where first obtainer 21 includes, for example, a sound collector and where user U1 and the like are within a range where sound can reach, for example, in the same room, first obtainer 21 can directly obtain the sound information based on the speech by each of user U1 and the like. Moreover, first obtainer 21 may obtain the sound information indicating the speech from sound collectors respectively corresponding to user U1 and the like.

Moreover, first obtainer 21 obtains, for example, input information based on input from at least one user among user U1 and the like. In a case where first obtainer 21 includes, for example, an obtaining device (for example, a communication circuit) that obtains the input information input from user U1 and the like through input devices, such as mice, touch panels, and keyboards and where user U1 and the like are, for example, in the same room, first obtainer 21 can obtain the input information from the input devices respectively corresponding to user U1 and the like.

The input information includes information indicating whether the manipulation of object O by the user is to be reflected in images P viewed by the other users. The input information may include, for example, information indicating that the target user has selected whether the manipulation by the target user is to be reflected in images P viewed by the other users. Moreover, the input information may include information indicating the current presenter. The information indicating the current presenter is an example of information indicating whether the target user is a presenter. Moreover, the input information may include information indicating the current work mode (for example, an individual work mode or a group work mode described later).

Moreover, first obtainer 21 may include, for example, a communication circuit to be able to communicate with at least one of the sound collector or the input devices.

Second obtainer 22 obtains second information indicating manipulation of object O by user U1 and the like. Second obtainer 22 obtains the second information from controllers, sound collectors, cameras, or the like respectively corresponding to user U1 and the like. Second obtainer 22 includes, for example, a communication circuit to be able to communicate with at least one of the controllers, the sound collectors, or the cameras. Moreover, second obtainer 22 may include a controller, a sound collector, a camera, or the like integrated therein and may directly obtain the second information.

Determiner 23 determines whether the manipulation of object O by the target user (for example, user U1) among user U1 and the like is to be reflected in objects O in images P viewed by the other users (for example, at least one of users U2 to U4) on the basis of the first information obtained by first obtainer 21. Determiner 23 may conduct the determination at regular intervals or every time the manipulation of object O by the target user is detected. Note that “reflecting the manipulation of object O by the target user in objects O in images P viewed by the other users” may also be simply referred to as “applying to the other users” or “reflecting in images P viewed by the other users”.

Generator 24 generates images P viewed by user U1 and the like on the basis of the result of determination by determiner 23 and the second information. Generator 24 generates images P according to user U1 and the like for each of the users, for example. To generate image P viewed by user U2, for example, generator 24 generates image P showing the avatars of users U1, U3, and U4 and object O viewed from the viewpoint of user U2 in FIG. 1. In this manner, each of user U1 and the like views image P in which, for example, object O is viewed from the viewpoint according to the position of their own avatar.

Generator 24 may generate images P viewed by user U1 and the like using an image including object O stored in head-mounted display 10 in advance.

Moreover, although described in detail later, generator 24 reflects the manipulation of object O by the target user in images P viewed by the other users when determiner 23 determines that the manipulation by the target user is to be applied to the other users, whereas generator 24 does not reflect the manipulation by the target user in images P viewed by the other users when determiner 23 determines that the manipulation by the target user is not to be applied to the other users. For example, when determiner 23 determines that the manipulation of object O by the target user is to be applied to the other users, generator 24 generates images P in which the manipulation by the target user is reflected as images P viewed by the other users. Moreover, for example, when determiner 23 determines that the manipulation by the target user is not to be applied to the other users, generator 24 generates images P in which the manipulation by the target user is not reflected as images P viewed by the other users.

Outputter 25 outputs images P generated by generator 24 to head-mounted displays 10 worn by user U1 and the like. Outputter includes, for example, a communication circuit to be able to communicate with head-mounted displays 10.

[2. Operation of work support system]

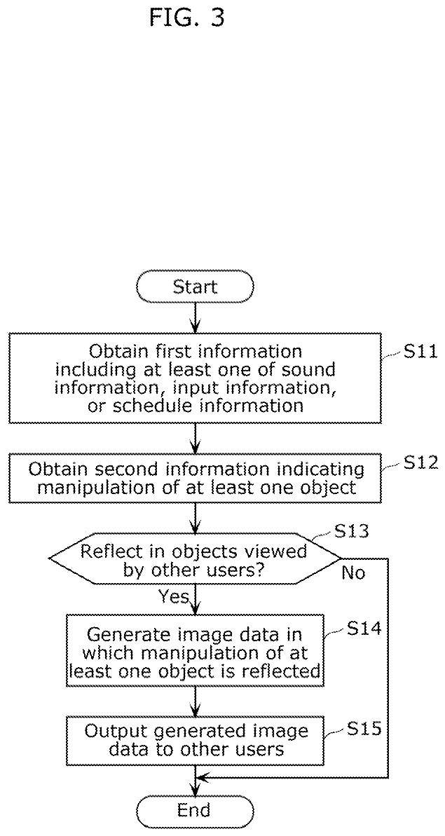

Next, operation of work support system 1 configured as above will be described with reference to FIGS. 3 to 8. FIG. 3 is a flowchart illustrating operation of information processor 20 according to this embodiment. Note that the flowchart in FIG. 3 illustrates the operation in a case where user U1 and the like are in virtual space S. Moreover, information processors 20 included in head-mounted displays 10 worn by user U1 and the like each perform the operation illustrated in FIG. 3. Information processors 20 included in head-mounted displays 10 worn by user U1 and the like may perform the operation illustrated in FIG. 3 independently of each other or in a coordinated manner.

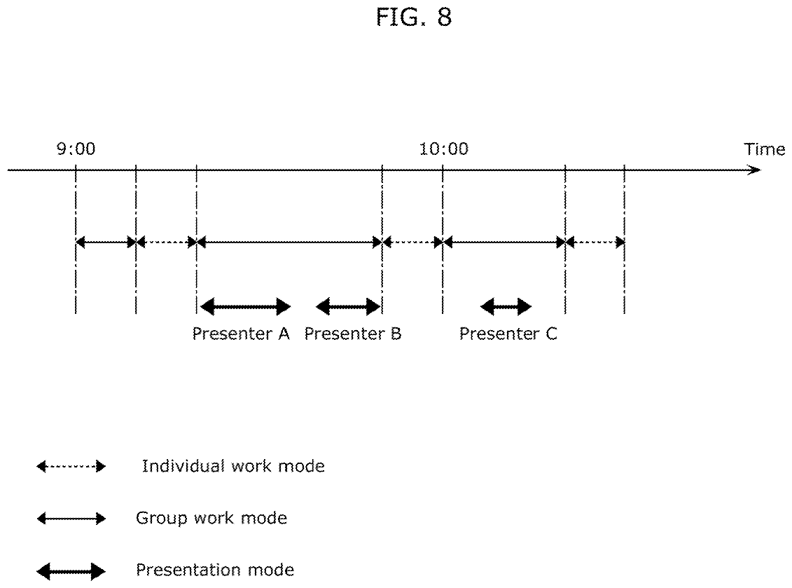

As illustrated in FIG. 3, first obtainer 21 obtains at least one of sound information about speech by user U1 and the like, input information about input from user U1 and the like, or schedule information (S11). First obtainer 21 obtains, for example, the sound information based on the speech by user U1 and the like in virtual space S. The sound information need only include the speech by at least one user among user U1 and the like. Moreover, first obtainer 21 obtains, for example, the input information. The input information need only include the input from at least one user among user U1 and the like. Moreover, first obtainer 21 obtains, for example, the schedule information from user U1 and the like or a management device (not illustrated) that manages the schedule of a design review meeting or the like using virtual space S. The schedule information is information in which, for example, time periods (time sections) are associated with information indicating whether the manipulation of object O by a target user is to be applied to other users. The schedule information may be information, for example, illustrated in FIG. 8 described later. The schedule information may be stored in a storage (not illustrated) included in head-mounted display 10, and first obtainer 21 may read out the schedule information from the storage.

First obtainer 21 outputs obtained first information to determiner 23.

Next, second obtainer 22 obtains second information indicating manipulation of at least one object O (S12). Second obtainer 22 obtains the second information for each of user U1 and the like. Second obtainer 22 outputs the obtained second information to generator 24. In the example below, the second information includes information indicating the manipulation of at least one object O by the target user.

Next, determiner 23 determines, on the basis of the first information, whether the manipulation of object O by the target user in image P at which the target user is looking is to be reflected in objects O in images P at which the other users are looking (S13). In step S13, it is determined whether the manipulation is to be applied to the other users and, when the manipulation is determined to be applied to the other users, it is determined whether the manipulation is to be applied to all the other users or some of the users. The determination method will be described in detail later.

Next, when determiner 23 determines that the manipulation is to be reflected in objects O viewed by the other users (Yes in S13), generator 24 generates image data (images P) in which the manipulation of at least one object O is reflected (S14). Generator 24 generates image data for, for example, each of the other users or some users among the other users by reflecting the manipulation of object O by the target user.

For example, in a case where the target user is user U1, where the other users are users U2 to U4, and where the manipulation by user U1 is to rotate object O by a predetermined angle, generator 24 rotates objects O in images P respectively viewed by users U2 to U4 by the predetermined angle. Moreover, generator 24 generates image data according to users U2 to U4 for each of the users. Generator 24 outputs the generated image data to outputter 25.

Next, outputter 25 outputs the image data (images P) generated by generator 24 to head-mounted displays 10 respectively worn by the other users (for example, users U2 to U4; S15). This allows changes in the appearance of object O to be shared between the target user and the other users.

Moreover, when determiner 23 determines that the manipulation is not to be reflected in objects O viewed by the other users (No in S13), generator 24 does not reflect the manipulation of at least one object O by the target user in images P viewed by the other users. The case of No in step S13 can also be referred to as a state where the manipulation of at least one object O by the target user is reflected only in image P viewed by the target user.

The operation illustrated in FIG. 3 is repeated, for example, at predetermined time intervals.

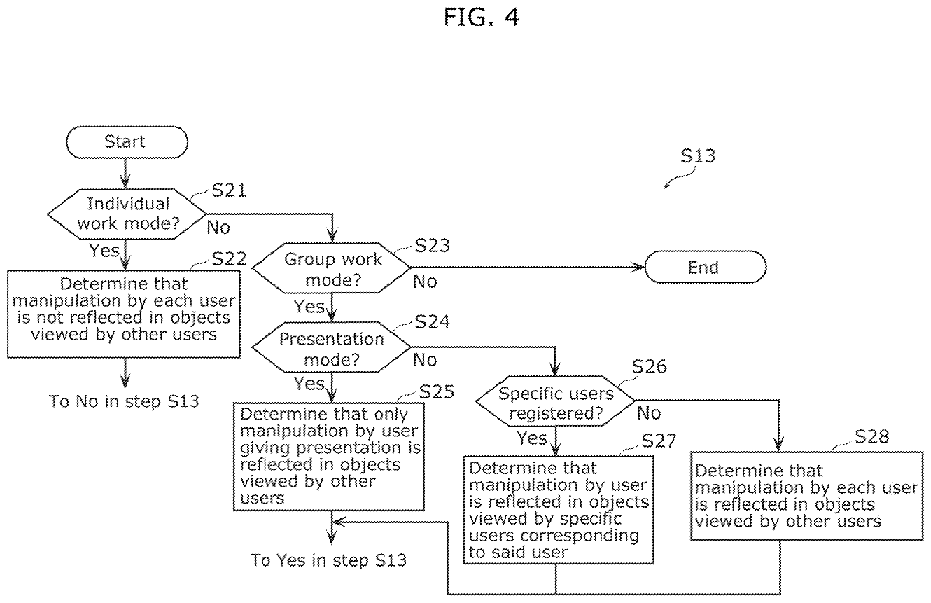

Next, the process in step S13 will be described with reference to FIGS. 4 to 8. FIG. 4 is a flowchart illustrating an example of details of step S13 illustrated in FIG. 3. Step S13 is a process performed while user U1 and the like are in virtual space S, for example, while members who conduct a meeting are gathering in virtual space S.

As illustrated in FIG. 4, determiner 23 first determines whether the current mode is the individual work mode on the basis of the first information (S21). The individual work mode is a mode in which each of user U1 and the like works individually while the users are in virtual space S.

For example, in a case where the first information includes at least schedule information (see FIG. 8 described later) including time periods during which the individual work mode is active and time periods during which the group work mode is active, determiner 23 may determine that the current mode is the individual work mode when the current time is in one of the time periods during which the individual work mode is active.

Moreover, for example, in a case where the first information includes at least sound information, determiner 23 may analyze the content of speech by user U1 and the like based on the sound information to conduct the determination in step S21 on the basis of the results of analysis of the speech content. The analysis of the speech content may correspond to, for example, detecting predetermined keywords from the sound information. The keywords are words for identifying whether the current mode is the individual work mode or the group work mode. Determiner 23 determines that the mode is the individual work mode when, for example, keywords such as “work individually”, “examine individually”, “will not be reflected”, “break”, and the like are detected.

Moreover, determiner 23 may determine that the mode is the individual work mode upon obtaining, for example, input indicating that the current work mode is the individual work mode from one of the users.

When the mode is the individual work mode (Yes in S21), determiner 23 determines that the manipulation by each user is not to be reflected in objects O viewed by the other users (S22). This corresponds to No in step S13. Moreover, in the case of Yes in step S21, the manipulation of objects O by each user can also be considered to be low in commonness (for example, lower than a predetermined reference value). “Low in commonness” may correspond to, for example, “not being common”.

Note that information processor 20 may continue to obtain the first information about user U1 and the like after the determination in step S22.

Moreover, when the mode is not the individual work mode (No in S21), determiner 23 further determines whether the mode is the group work mode on the basis of the first information (S23). The group work mode is a mode in which user U1 and the like work on at least one object O in a coordinated manner while user U1 and the like are in virtual space S. For example, in a case where the first information includes the schedule information, determiner 23 may determine that the current mode is the group work mode when the current time is in one of the time periods during which the group work mode is active.

Moreover, for example, in a case where the first information includes the sound information, determiner 23 may analyze the content of speech by user U1 and the like based on the sound information to conduct the determination in step S23 on the basis of the results of analysis of the speech content. The analysis of the speech content may be, for example, detecting predetermined keywords from the sound information. The keywords are words for identifying whether the current mode is the group work mode. Determiner 23 determines that the mode is the group work mode when, for example, keywords such as “start of meeting”, “will be reflected”, “end of break”, and the like are detected.

Moreover, determiner 23 may determine that the mode is the group work mode upon obtaining, for example, input indicating that the current work mode is the group work mode from one of the users.

The process proceeds to step S24 when the mode is the group work mode (Yes in S23), whereas determiner 23 ends the process when the mode is not the group work mode (No in S23). Note that, in the case of Yes in step S23, the manipulation of object O by each user can also be considered to be high in commonness (for example, higher than the predetermined reference value). “High in commonness” may correspond to, for example, “being common”. Steps S21 and S23 can also be considered as the process of determining whether the manipulation is common.

In the case of the group work mode, determiner 23 further determines whether a presentation mode is active (S24). The presentation mode is a mode included in the group work mode and allows at least one user to give a presentation to the other users during the group work mode.

For example, in a case where the first information includes the schedule information including time periods during which the presentation mode is active, determiner 23 may determine that the current mode is the presentation mode when the current time is in one of the time periods during which the presentation mode is active. In this case, the schedule information may include information for identifying users (presenters) who give presentations.

Moreover, for example, in the case where the first information includes the sound information, determiner 23 may analyze the content of speech by user U1 and the like based on the sound information to conduct the determination in step S24 on the basis of the results of analysis of the speech content. The analysis of the speech content may be, for example, detecting predetermined keywords from the sound information. The keywords are words for identifying whether the current mode is the presentation mode. Determiner 23 determines that the mode is the presentation mode when, for example, words such as “X will explain . . . ”, “I will explain . . . ”, and the like are detected.

Moreover, determiner 23 may determine that the mode is the presentation mode upon obtaining, for example, input indicating that the current mode is the presentation mode from one of the users.

When the mode is the presentation mode (Yes in S24), determiner 23 determines that only the manipulation by the users who are giving presentations (presenters) is to be reflected in objects O viewed by the other users (for example, all the other users; S25).

When the mode is not the presentation mode (No in S24), determiner 23 determines whether specific users are registered (S26). The specific users are users, among the other users, to whom the manipulation by the target user is to be applied. The specific users may be, for example, registered for each of user U1 and the like in advance and stored in memory (not illustrated) included in information processor 20, or may be obtained from a user (for example, the target user) when it is determined that the mode is not the presentation mode (No in step S24).

When the specific users are registered (Yes in S26), determiner 23 determines that the manipulation by a user (target user) is to be reflected in objects O viewed by the specific users corresponding to the user (S27). In the case of Yes in step S26, the manipulation of object O by the target user is reflected only in images P viewed by some of the users among the other users except for the target user. Moreover, when the specific users are not registered (No in S26), determiner 23 determines that the manipulation by each user is to be reflected in objects O viewed by the other users (S28). In the case of No in step S26, the manipulation of object O by the target user is reflected equally in images P viewed by all the other users except for the target user.

Note that the determinations in steps S25, S27, and S28 correspond to Yes in step S13.

As described above, upon determining that the mode is the group work mode, determiner 23 further determines whether the target user is a presenter. Determiner 23 determines that the manipulation of at least one object O by the target user is to be applied to the other users when the target user is determined to be a presenter, whereas determiner 23 determines that the manipulation of at least one object O by the target user is not to be applied to the other users when the target user is determined not to be a presenter.

Note that the determinations in steps S21, S23, and S24 may be conducted for each time section on the basis of the first information, for example. The time sections may be time periods included in the schedule information or the like and may be predetermined time sections (for example, five minutes, ten minutes, and the like). Determiner 23 determines whether the mode is the individual work mode in step S21 and whether the mode is the group work mode in step S23. Determiner 23 determines that the manipulation of at least one object O by the target user in a time section during which the group work mode is determined to be active is to be applied to the other users, whereas determiner 23 determines that the manipulation of at least one object O by the target user in a time section during which the individual work mode is determined to be active is not to be applied to the other users. Note that steps S21 and S23 may be performed during one determination.

FIG. 4 illustrates three modes including the individual work mode, the group work mode, and the presentation mode. However, the number of modes is not limited to this and may be two, or four or more. In a case where the number of modes is two, the two modes may be two selected from the individual work mode, the group work mode, and the presentation mode.

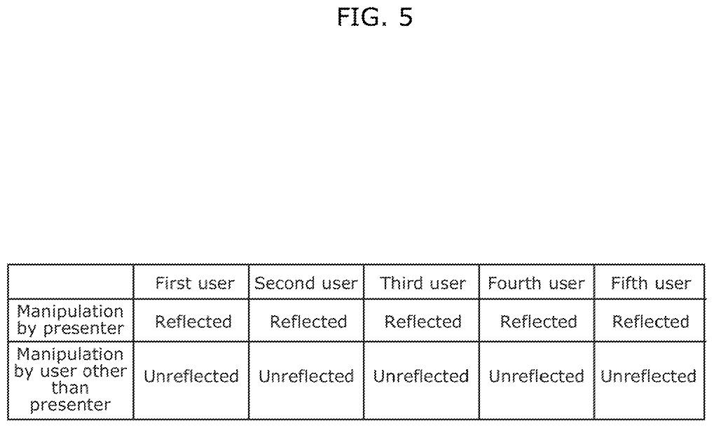

Next, images P generated when the determinations in steps S25, S27, and S28 are conducted will be described with reference to FIGS. 5 to 7. FIG. 5 illustrates whether the manipulation by the target user is to be applied to each user when the determination in step S25 illustrated in FIG. 4 is conducted. Note that six users, the target user and first to fifth users, are in virtual space S in the example illustrated in FIGS. 5 to 7. The first to fifth users are an example of the other users.

As illustrated in FIG. 5, the manipulation of at least one object O by the target user is reflected in images P viewed by the first to fifth users when the target user is a presenter, whereas the manipulation of at least one object O by the target user is not reflected (unreflected) in images P viewed by the first to fifth users when the target user is not a presenter. In this manner, applying only the manipulation by the presenter to the other users allows the other users to view images P that match the explanation given by the presenter. Moreover, the manipulation by a person who is not a presenter is not applied to the other users, preventing images P that do not match the explanation given by the presenter from being shared with the other users. Note that the number of presenters is not limited to one and may be two or more.

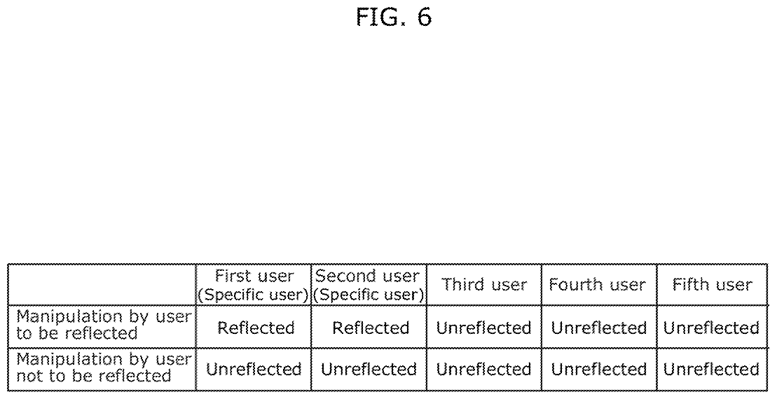

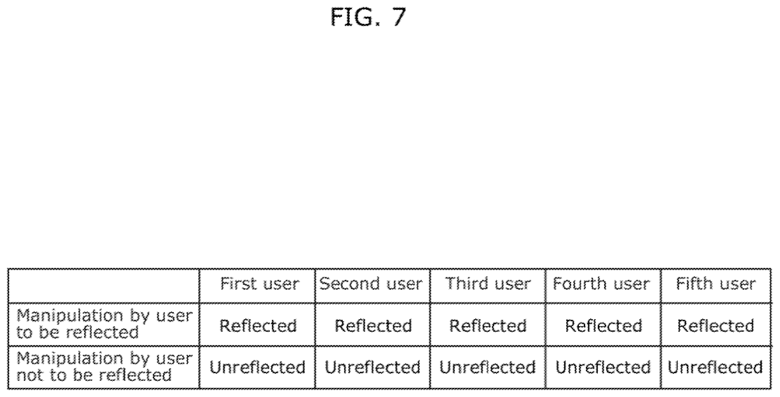

FIG. 6 illustrates whether the manipulation by the target user is to be applied to each user when the determination in step S27 illustrated in FIG. 4 is conducted. FIG. 6 illustrates an example where the first and second users are specific users and where the third to fifth users are not specific users. Note that “manipulation by user to be reflected” illustrated in FIGS. 6 and 7 refers to the manipulation by users in the case of No in step S24. Moreover, “manipulation by user not to be reflected” illustrated in FIGS. 6 and 7 refers to the manipulation by users in the case of Yes in step S21. In the case of “manipulation by user not to be reflected”, that is, when the target user is not the user by whom the manipulation is to be reflected, the manipulation of at least one object O by the target user is not reflected (unreflected) in images P viewed by the first to fifth users.

As illustrated in FIG. 6, when the target user is the user by whom the manipulation is to be reflected, the manipulation of at least one object O by the target user is reflected only in images P viewed by the first and second users among the first to fifth users, and the manipulation of at least one object O by the target user is not reflected (unreflected) in images P viewed by the third to fifth users. In this case, in step S14, generator 24 generates image data in which the manipulation of at least one object O by the target user is applied to the specific users among the other users. Note that the specific users do not include all the other users.

In this manner, applying the manipulation of at least one object O by the target user only to the specific users allows the target user to share image P only with desired users. The first and second users are an example of at least one specific user.

Note that the specific users are determined in advance for each of user U1 and the like and may be stored in the memory of information processor 20.

Note that the specific users may be determined according to input from the target user in a period in which the manipulation by the target user is determined to be applied to the other users. For example, the specific users may be obtained and determined by input from the target user during the group work mode.

Note that the specific users may be automatically determined on the basis of at least one of information indicating the positions of the other users in virtual space S or information indicating the attributes of the other users. The information indicating the positions of the other users in virtual space S may include, for example, information indicating relative positional relationships between the target user or a predetermined object, such as a table, in virtual space S and the other users in virtual space S. For example, the information indicating the positions of the other users in virtual space S may include, for example, information indicating whether the users are within a predetermined distance from the target user or the predetermined object. Determiner 23 may determine, for example, the other users within the predetermined distance from the target user or the predetermined object as the specific users. Moreover, the information indicating the attributes of the other users includes, for example, information indicating at least one of the department, title, gender, age, role in the meeting, or the like of each user. For example, on the basis of a list of attributes of users to whom the manipulation by the target user is to be applied, determiner 23 may determine the other users whose attributes match those in the list as the specific users corresponding to the target user. Note that the information about the attributes of the users may be obtained from the users when, for example, the users enter virtual space S.

FIG. 7 illustrates whether the manipulation by the target user is to be applied to each user when the determination in step S28 illustrated in FIG. 4 is conducted.

As illustrated in FIG. 7, when the target user is the user by whom the manipulation is to be reflected, the manipulation of at least one object O by the target user is reflected in images P viewed by the first to fifth users. For example, the manipulation of at least one object O by any of user U1 and the like is also applied to the other users. In this manner, applying the manipulation of at least one object O by the target user to all the other users allows the target user to share image P with the users in virtual space S.

FIG. 8 illustrates the schedule information according to this embodiment.

As illustrated in FIG. 8, the schedule information is information in which, for example, time and the modes are associated with each other. The schedule information may also be considered to include information indicating the time periods during which the group work mode is active and the time periods during which the individual work mode is active. Moreover, the schedule information includes information about the time periods during which the presentation mode is active and the presenters in the time periods during which the group work mode is active. For example, in the group work mode starting from 10 o'clock, the presentation mode, in which C serves as a presenter, becomes active. C is an example of the target user.

In this case, for example, in the group work mode starting from 10 o'clock, the manipulation by the target user is applied to the other users according to the determination in step S27 or S28 illustrated in FIG. 4. When the time at which C serves as the presenter arrives, the determination in step S25 is conducted, and only the manipulation by C is applied to the other users. That is, when the work mode is switched from the group work mode to the presentation mode in the group work mode, the user (for example, the target user) by whom the manipulation of at least one object O can be applied to the other users is switched.

In this manner, the user by whom the manipulation can be applied to the other users can be changed according to the mode or the like at the moment. Note that, for example, the schedule information illustrated in FIG. 8 is obtained in step S11 illustrated in FIG. 3.

### OTHER EMBODIMENTS

Although a work support method and the like according to one or more aspects have been described above on the basis of the foregoing embodiment, this embodiment is not intended to limit the present disclosure. The scope of the present disclosure may encompass forms obtained by various modifications, to the embodiments, that can be conceived by those skilled in the art and forms obtained by combining elements in different embodiments without departing from the spirit of the present disclosure.

For example, methods of communication, according to the above-described embodiments, by which head-mounted display 10 and information processor 20 communicate with each other are not limited in particular. Head-mounted display 10 and information processor 20 communicate with each other, for example, wirelessly, but may communicate with each other using a wired connection. Moreover, the communication standard used for the wireless or wired connection is not limited in particular, and any communication standard can be used.

Moreover, in the above-described embodiments, object O is an automobile. However, object O may be a vehicle other than the automobile, such as a train; may be a household electrical appliance, such as a display, a lighting device, or a smartphone; may be a flying object, such as a drone; may be a garment; may be a piece of furniture; may be a white board, a label, or the like; or may be an article of food. The manipulation of object O may be manipulation for implementing the function of object O. For example, the manipulation of object O in a case where object O is a display may be manipulation that causes image P to be shown in the display. Moreover, for example, the manipulation of object O in a case where object O is a label may be manipulation that causes letters to be written on the label. The manipulation of object O may be manipulation that causes at least part of the appearance in virtual space S to be changed.

Moreover, in the above-described embodiments, determiner 23 determines the work mode such as the individual work mode in step S13. However, the determination in step S13 is not limited to determining the work mode. Determiner 23 may conduct the determination in step S13 on the basis of, for example, the first information. For example, in a case where the sound information includes information indicating the specific users, determiner 23 may directly conduct the determination in step S27 on the basis of the sound information.

Moreover, upon generating images P in which the manipulation of at least one object O by the target user is reflected, generator 24 in the above-described embodiments may superpose information indicating the target user on images P. That is, generator 24 may display the user, among user U1 and the like, by whom the manipulation is reflected in images P. Moreover, when determiner 23 determines the current work mode, generator 24 in the above-described embodiments may superpose information indicating the current work mode on images P to be generated.

Moreover, information processor 20 corresponding to the target user in the above-described embodiments may be able to communicate with information processors 20 corresponding to the other users. Information processor 20 corresponding to the target user may output information obtained in at least one of step S11 or step S12 to information processors 20 corresponding to the other users.

Moreover, object O in the above-described embodiments is, for example, a three-dimensional object, but may be a two-dimensional object.

Moreover, the target user in the above-described embodiments is one of the multiple users, but may be two or more users among the multiple users.

Moreover, image P in the above-described embodiments is, for example, a moving image, but may be a still image. Moreover, image P may be, for example, a color image or a monochrome image.

Moreover, in the above-described embodiments, the elements may be configured by dedicated hardware or achieved by executing software programs suitable for the elements. The elements may be achieved as a program executor, such as a CPU or a processor, reads out and executes software programs stored in a recording medium, such as a hard disk or semiconductor memory.

Moreover, the orders in which the steps in the flowcharts are performed are examples to explain the present disclosure specifically, and may be orders other than the above. Moreover, some of the above-described steps may be performed simultaneously (in parallel) with the other steps, and some of the above-described steps do not need to be performed.

Moreover, divisions of functional blocks in the block diagram are mere examples. Multiple functional blocks may be implemented as one functional block, one functional block may be divided into multiple functional blocks, and some functions may be moved to other functional blocks. Moreover, functions of multiple functional blocks having similar functions may be processed by a single hardware or software in parallel or in a time-shared manner.

Moreover, information processor 20 according to the above-described embodiments may be implemented as a single device or achieved by multiple devices. In a case where information processor is achieved by multiple devices, the elements included in information processor 20 may be freely distributed to the multiple devices. Among functional configurations included in information processor 20, at least one functional configuration may be achieved by, for example, a cloud server. Information processor 20 in this specification also includes a configuration in which the function of information processor 20 is achieved by head-mounted display 10 and a cloud server. In this case, head-mounted displays 10 worn by user U1 and the like are each connected to the cloud server to be able to communicate with the cloud server. For example, elements with high throughput, such as generator 24, may be achieved by a cloud server or the like. In the case where information processor 20 is achieved by multiple devices, methods of communication between the multiple devices are not limited in particular, and may be wireless or wired. Moreover, wireless and wired communications may be combined between the devices.

Moreover, in a case where information processor 20 according to the above-described embodiments has a configuration that enables acquisition of positional information possessed by head-mounted display 10 (for example, in a case where information processor 20 has a GPS (Global Positioning System) sensor), information processor may generate images P according to the positions of user U1 and the like.

Moreover, the elements described in the embodiments above may be implemented as software or may be implemented typically as LSI circuits, which are integrated circuits. These elements may be individually formed into single chips, or some or all of the elements may be collectively formed into a single chip. LSI circuits herein may also be referred to as ICs, system LSI circuits, super LSI circuits, or ultra LSI circuits depending on the degree of integration. Moreover, the circuit integration method is not limited to LSI, and the elements may be achieved by dedicated circuits or general-purpose processors. After the LSI circuits are produced, FPGAs (Field Programmable Gate Arrays) that are programmable or reconfigurable processors with which connections or settings of circuit cells inside the LSI circuits can be reconfigured may be used. Furthermore, if a circuit integration technology that can replace LSI emerges due to the advance of semiconductor technology or other derived technologies, the elements may be integrated using the technology as a matter of course.

A system LSI circuit is a super multifunctional LSI circuit produced by integrating multiple processors on one chip, and, specifically, is a computer system including a microprocessor, ROM (Read Only Memory), RAM (Random Access Memory), and the like. The ROM stores computer programs. As the microprocessor operates according to the computer programs, the system LSI circuit achieves its functions.

Moreover, an aspect of the present disclosure may be a computer program that causes a computer to perform distinctive steps included in the work support method illustrated in FIG. 3 or 4.

Moreover, for example, a program may be a program to be executed by a computer. Moreover, an aspect of the present disclosure may be a non-transitory computer-readable recording medium storing such a program. For example, such a program may be stored in recording media to be distributed or circulated. For example, causing the distributed program to be installed in a device including another processor and to be executed by the processor enables the device to perform the above-described processes.

### INDUSTRIAL APPLICABILITY

The present disclosure is useful for server devices and the like that support work performed by multiple users in virtual spaces.

1. A work support method for supporting work performed by a plurality of users including a target user on at least one object in a virtual space where the at least one object is placed, the work support method comprising:
obtaining first information including at least one of sound information based on speech by at least one user among the plurality of users, input information based on input from the at least one user among the plurality of users, or schedule information based on a plan about the work;
obtaining second information indicating manipulation of the at least one object by the target user;
determining whether the manipulation by the target user is to be applied to one or more other users among the plurality of users based on the first information;
generating images each viewed by a corresponding one of the one or more other users based on a result of the determining and the second information; and
outputting the images that are generated to terminals of the one or more other users.

2. The work support method according to claim 1, wherein
the first information includes at least the sound information, and
the determining is conducted based on a result of an analysis obtained by analyzing content of the speech by the at least one user based on the sound information.

3. The work support method according to claim 1, wherein
the determining includes:
determining whether either a group work mode in which the plurality of users work in a coordinated manner or an individual work mode in which the plurality of users work individually is active for each of time sections based on the first information; and
determining that the manipulation by the target user in each of the time sections in which the group work mode is determined to be active is to be applied to the one or more other users and that the manipulation by the target user in each of time sections in which the individual work mode is determined to be active is not to be applied to the one or more other users.

4. The work support method according to claim 3, wherein
the determining further includes:
when the group work mode is determined to be active, determining whether the target user is a presenter; and
determining that the manipulation by the target user is to be applied to the one or more other users when the target user is determined to be the presenter and that the manipulation by the target user is not to be applied to the one or more other users when the target user is determined not to be the presenter.

5. The work support method according to claim 4, wherein
the first information includes at least the input information, and
the input information includes information indicating whether the target user is the presenter.

6. The work support method according to claim 1, wherein
in the generating, the manipulation by the target user is reflected in the images viewed by the one or more other users when the manipulation by the target user is determined to be applied to the one or more other users, and the manipulation by the target user is not reflected in the images viewed by the one or more other users when the manipulation by the target user is determined not to be applied to the one or more other users.

7. The work support method according to claim 1, wherein
in the generating, when the manipulation by the target user is determined to be applied to the one or more other users, the manipulation by the target user is reflected in an image viewed by at least one specific user among the plurality of users and is not reflected in an image viewed by a user other than the at least one specific user among the one or more other users.

8. The work support method according to claim 7, wherein
the at least one specific user is determined in advance for each of the plurality of users.

9. The work support method according to claim 7, wherein
the at least one specific user is determined according to input from the target user in a period in which the manipulation by the target user is determined to be applied to the one or more other users.

10. The work support method according to claim 7, wherein
the at least one specific user is determined based on at least one of information indicating positions of the one or more other users in the virtual space or information indicating attributes of the one or more other users.

11. The work support method according to claim 3, wherein
the first information includes at least the schedule information, and
the schedule information includes information indicating a time period during which the group work mode is active and a time period during which the individual work mode is active.

12. The work support method according to claim 1, wherein
the manipulation of the at least one object includes at least one of moving, rotating, enlarging, or shrinking the at least one object.

13. A work support device that supports work performed by a plurality of users including a target user on at least one object in a virtual space where the at least one object is placed, the work support device comprising:
a first obtainer that obtains first information including at least one of sound information based on speech by at least one user among the plurality of users, input information indicating input from the at least one user among the plurality of users, or schedule information indicating a plan about the work;
a second obtainer that obtains second information indicating manipulation of the at least one object by the target user;
a determiner that conducts determination of whether the manipulation by the target user is to be applied to one or more other users among the plurality of users based on the first information;
a generator that generates images each viewed by a corresponding one of the one or more other users based on a result of the determining and the second information; and
an outputter that outputs the images that are generated to terminals of the one or more other users.

14. A non-transitory computer-readable recording medium having recorded thereon a program for causing a computer to execute the work support method according to claim 1.
